(19) United States
(12) Patent Application Publication
(10) Pub. No.: US 2026/0096513 A1
(43) Pub. Date: Apr. 9, 2026

(54) SYSTEM FOR SIDE-TO-SIDE DRUM LEVELING

(71) Applicant: CNH Industrial America LLC, New Holland, PA (US)

(72) Inventors: Daniel Arthur Krieg, Anamosa, IA (US); Michael John Minnich, Elizabethtown, PA (US); Timothy Alan Meeks, Donahue, IA (US)

(21) Appl. No.: 19/339,570

(22) Filed: Sep. 25, 2025

Related U.S. Application Data
(60) Provisional application No. 63/704,856, filed on Oct. 8, 2024.

(51) Int. Cl. A01D 46/08; A01D 69/03

(52) U.S. Cl. CPC A01D 46/085; A01D 69/03

(57) ABSTRACT

A system includes a hanger assembly configured to couple to a drum that includes a first vertical arm bracket and a second vertical arm bracket configured to couple to the drum. The first vertical arm bracket includes a first end and a second end opposite the first end, wherein the first end is configured to couple to the housing and the second end is coupled to a first hub coupled to a first roller. The hanger assembly is configured to hang on a toolbar of a header of the agricultural harvester via the first roller and a second roller. The first roller is coupled to a cam system configured to adjust a position of the first roller relative to the toolbar to adjust a levelness of the drum relative to an adjacent drum hanging on the toolbar.

### CROSS-REFERENCE TO RELATED APPLICATION

This application claims priority from and the benefit of U.S. Provisional Application Serial No. 63/704,856, entitled “SYSTEM FOR SIDE-TO-SIDE DRUM LEVELING”, filed October 8, 2024, which is hereby incorporated by reference in its entirety.

### BACKGROUND

The present disclosure relates generally to a system for side-to-side drum leveling for a row unit of an agricultural harvester.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a system for adjusting a leveling of a drum of a row unit of an agricultural harvester includes a hanger assembly configured to couple to a drum that is configured to pick an agricultural product. The hanger assembly includes a first vertical arm bracket and a second vertical arm bracket configured to couple to opposite sides of a housing of the drum. The first vertical arm bracket includes a first end and a second end opposite the first end, wherein the first end is configured to couple to the housing and the second end is coupled to a first hub coupled to a first roller. The second vertical arm bracket includes a third end and a fourth end opposite the third end, wherein the third end is configured to couple to the housing and the fourth end is coupled to a second hub coupled to a second roller. The hanger assembly is configured to hang on a toolbar of a header of the agricultural harvester via the first roller and the second roller. The first roller is coupled to a cam system configured to adjust a position of the first roller relative to the toolbar to adjust a levelness of the drum relative to an adjacent drum hanging on the toolbar.

In certain embodiments, a system for adjusting a leveling of a drum of a row unit of an agricultural harvester includes a carriage assembly configured to couple to a drum that is configured to pick an agricultural product. The carriage assembly includes a first pair of rollers configured to interface with a top of a toolbar of a header of the agricultural harvester with a first roller and a second roller of the first pair of rollers disposed adjacent opposite longitudinal ends of the carriage assembly. The carriage assembly also includes a second pair of rollers configured to interface with a side of the toolbar with a third roller and a fourth roller of the second pair of rollers disposed adjacent the opposite longitudinal ends of the carriage assembly. The system also includes a first adjustment mechanism having a first end coupled to a first longitudinal end of the carriage assembly and a second end configured to couple to a first side of a housing of the drum. The system further includes a second adjustment mechanism having a third end coupled to a second longitudinal end of the carriage assembly opposite the first longitudinal end and a fourth end configured to couple to a second side of the housing of the drum opposite the first side. The first adjustment mechanism and the second adjustment mechanism are configured adjust a levelness of the drum relative to an adjacent drum hanging on the toolbar.

In certain embodiments, a row unit for an agricultural harvester includes a drum configured to pick an agricultural product and including a housing. The row unit also includes a hanger assembly coupled to the housing of the drum. The hanger assembly includes a first vertical arm bracket and a second vertical arm bracket coupled to opposite sides of the housing of the drum. The hanger assembly also includes a bracket extending between and coupled to the first vertical arm bracket and the second vertical arm bracket. The first vertical arm bracket includes a first end and a second end opposite the first end, wherein the first end is coupled to the housing and the second end is coupled to a first hub coupled to a first roller. The second vertical arm bracket includes a third end and a fourth end opposite the third end, wherein the third end is coupled to the housing and the fourth end is coupled to a second hub coupled to a second roller, wherein the hanger assembly is configured to hang on a toolbar of a header of the agricultural harvester via the first roller and the second roller. The first roller is coupled to a cam system configured to adjust a position of the first roller relative to the toolbar to adjust a levelness of the drum relative to an adjacent drum hanging on the toolbar.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header;

FIG. 2 is a schematic view of an embodiment of an agricultural product transport assembly and an embodiment of a baler that may be employed within the agricultural harvester of FIG. 1;

FIG. 3 is a perspective view of an embodiment of a header that may be employed within the agricultural harvester of FIG. 1 and an embodiment of an air-assisted conveying system that may be employed within the agricultural product transport assembly of FIG. 2;

FIG. 4 is a perspective view of an embodiment of a system for adjusting a leveling of a drum of a row unit that may be employed on the header in FIG. 3;

FIG. 5 is an exploded perspective view of a portion of the system in FIG. 4 for adjusting the leveling of the drum of the row unit;

FIG. 6 is a perspective view of the portion of the system in FIG. 4 for adjusting the leveling of the drum of the row unit;

FIG. 7 is an end view of a portion of the system in FIG. 4 for adjusting the leveling of the drum of the row unit;

FIG. 8 is a front perspective view of a portion of the system in FIG. 4 with a roller and offset-holed bushing in a neutral position;

FIG. 9 is a rear perspective view of a portion of the system in FIG. 4 with a roller and offset-holed bushing in a neutral position;

FIG. 10 is an end view of a portion of the system in FIG. 4 with a roller and offset-holed bushing in a high position;

FIG. 11 is a rear perspective view of a portion of the system in FIG. 4 with a roller and offset-holed bushing in a high position;

FIG. 12 is a perspective view of another embodiment of a system for adjusting a leveling of a drum of a row unit that may be employed on the header in FIG. 3;

FIG. 13 is a front view of the system in FIG. 12 for adjusting a leveling of a drum of a row unit;

FIG. 14 is rear perspective of a portion of the system in FIG. 12;

FIG. 15 is a perspective view of another embodiment of a system for adjusting a leveling of a drum of a row unit that may be employed on the header in FIG. 3;

FIG. 16 is a front view of the system in FIG. 15 for adjusting a leveling of a drum of a row unit; and

FIG. 17 is rear perspective of a portion of the system in FIG. 15.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

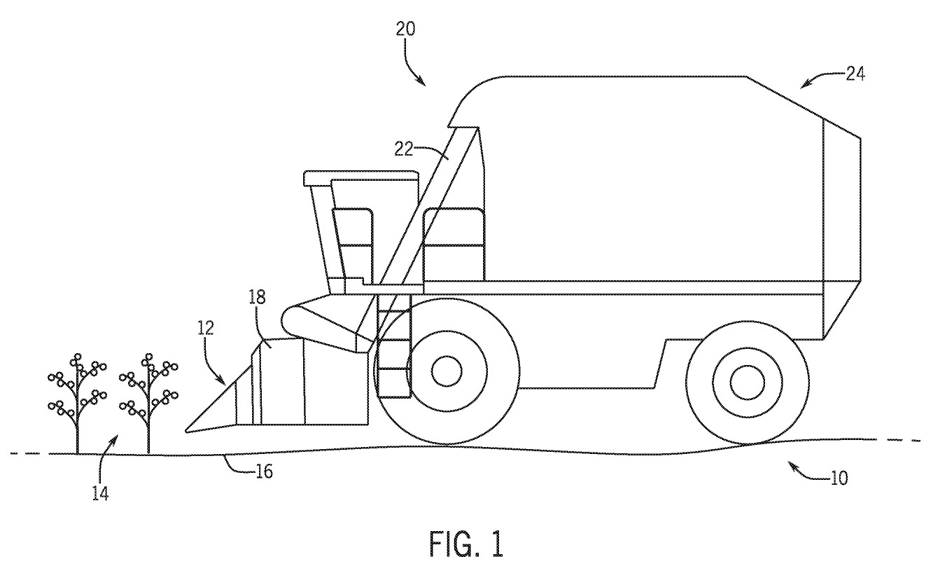

FIG. 1 is a side view of an embodiment of an agricultural harvester 10 having a header 12. The agricultural harvester 10 is configured to harvest agricultural product 14 (e.g., seed cotton) from a field 16 and to form the agricultural product 14 into bales (e.g., agricultural bales). In the illustrated embodiment, the header 12 of the agricultural harvester 10 includes multiple row units 18 distributed across the width of the header 12. Each row unit 18 is configured to harvest a respective row of the agricultural product 14 from the field 16. Additionally, the agricultural harvester 10 includes an agricultural product transport assembly 20 having an air-assisted conveying system 22 configured to move the agricultural product 14 from the row units 18 of the header 12 to an accumulator of the agricultural product transport assembly 20. The agricultural product transport assembly 20 also includes a conveying system configured to convey the agricultural product 14 from the accumulator into a baler 24. The baler 24 is supported by and/or mounted within or on a chassis of the agricultural harvester 10. The baler 24 may form the agricultural product 14 into round bales. However, in other embodiments, the baler 24 of the agricultural harvester 10 may form the agricultural product into square bales, polygonal bales, or bales of other suitable shape(s). After forming the agricultural product 14 into a bale, a bale wrapping system of the agricultural harvester 10 wraps the bale with a bale wrap to secure the agricultural product 14 within the bale and to generally maintain a shape of the bale.

In certain embodiments, each row unit 18 includes two rotors positioned on opposite sides of a central path through the row unit 18 or on the same side of the central path disposed within a drum. Each rotor includes multiple spindles (e.g., barbed spindles) extending into the central path, and the spindles are configured to engage a crop (e.g., cotton plant) along a substantial portion of the height of the crop. During operation of the agricultural harvester 10, the central path of the row unit 18 is aligned with a row of crops. Accordingly, as the agricultural harvester 10 traverses the field 16, the row unit 18 receives each crop of the row, and the spindles of the rotors engage the crop within the drum. The rotors are driven to rotate, such that engagement of the spindles with the crop separates the agricultural product (e.g., seed cotton) from the plant stalk (e.g., the crop after the agricultural product is removed). The agricultural product removed from the crop collects on the spindles, and the agricultural product is removed from the spindles by doffers. Each doffer directs the agricultural product to a respective conveying chamber, and airflow generated by the air-assisted conveying system 22 moves the agricultural product from the conveying chambers to the accumulator via a duct of the air-assisted conveying system 22. After the agricultural product is removed from the spindles of each rotor, the spindles pass through a moistener column assembly to remove buildup of crop liquids (e.g., sap, etc.) from the spindles. As the rotors continue to rotate, the spindles engage a subsequent crop at the central path, while the plant stalk remains attached to the ground.

In certain embodiments, at least one row unit 18 of the header 12 (e.g., each row unit 18 of the header 12) includes an outlet assembly configured to facilitate lateral movement of the row unit 18 along a chassis of the header 12. In such embodiments, the outlet assembly includes an input portion coupled to a frame of the row unit 18. The input portion includes an inlet configured to receive the agricultural product (e.g., from the conveying chambers of the row unit) and an outlet configured to expel the agricultural product. The outlet assembly also includes an output portion having an inlet configured to receive the agricultural product from the outlet of the input portion and an outlet configured to direct the agricultural product into a respective duct of the air-assisted conveying system 22.

The interaction with the crop may vary slightly row to row. This could cause cotton to be knocked off the plant prematurely and fall to the ground where is left as crop loss, thus, reducing the picking efficiency of each drum. As described in greater detail below, each drum is coupled to (e.g., hangs on) a toolbar of the header via system that is configured to level the drum relative to adjacent drums of other row units 18. The ability to level the individual drums relative to each other enables differences to be compensated for (e.g., manufacturing tolerances in the drum cabinet/hangers, bowing in the toolbar, etc.). Thus, the system for leveling may adjust for these differences, minimize crop loss, and increase the picking efficiency of each drum.

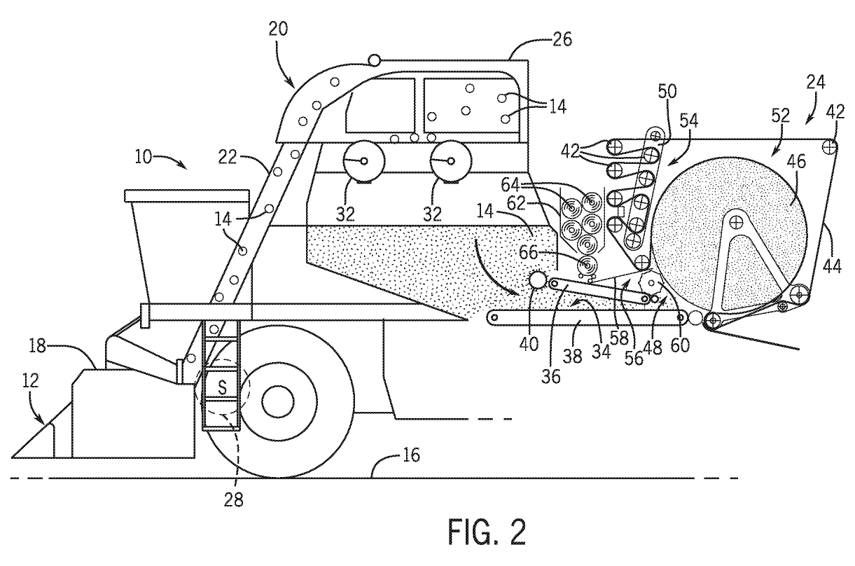

FIG. 2 is a schematic view of an embodiment of an agricultural product transport assembly 20 and an embodiment of a baler 24 that may be employed within the agricultural harvester 10 of FIG. 1. As previously discussed, the header 12 of the agricultural harvester 10 includes row units 18 configured to harvest the agricultural product 14 (e.g., seed cotton) from the field. Furthermore, the air-assisted conveying system 22 is configured to move the agricultural product 14 from the row units 18 (e.g., from the drums) of the header 12 to the accumulator 26. In the illustrated embodiment, the air-assisted conveying system 22 includes a conveying air source 28 configured to output a conveying air flow through ducts 30. Each duct 30 receives the agricultural product 14 (e.g., seed cotton) from a respective row unit 18 of the header 12, and the conveying air flow output by the conveying air source 28 drives the agricultural product to move through the ducts 30 from the header 12 to the accumulator 26. In the illustrated embodiment, the agricultural product transport assembly 20 includes augers 32 configured to distribute the agricultural product 14 (e.g., seed cotton) laterally across the accumulator 26 (e.g., crosswise to the downward movement of the agricultural product through the accumulator). In the illustrated embodiment, the agricultural product transport assembly 20 includes two augers 32. However, in other embodiments, the agricultural product transport assembly may include more or fewer augers (e.g., 0, 1, 3, 4, or more).

In the illustrated embodiment, the conveying system 34 of the agricultural product transport system 20 includes a first belt (e.g., belt) 36 configured to move the agricultural product 14 from the accumulator 26 to the baler 24. The first belt 36 is configured to rotate in a first rotational direction to move an agricultural product engaging surface of the first belt 36 toward the baler 24. Furthermore, in the illustrated embodiment, the conveying system 34 includes a second belt 38 positioned on an opposite side of the agricultural product 14 from the first belt 36, and the second belt 38 is configured to cooperate with the first belt 36 to move the agricultural product 14 from the accumulator 26 to the baler 24. Furthermore, in the illustrated embodiment, the conveying system 34 includes an agitation roller 40 positioned upstream of the first belt 36. The agitation roller 40 is configured to agitate the agricultural product 14 entering the pair of opposing belts, thereby enhancing the uniformity of the distribution of the agricultural product passing through the pair of opposing belts.

In the illustrated embodiment, the baler 24 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 14 from the conveying system 34 and draws the agricultural product 14 into a cavity 48, where the agricultural product 14 is gradually built up to form the bale 46.

In the illustrated embodiment, the baler 24 includes a tension arm 50 configured to establish tension within the belt(s) 44. As the agricultural product 14 builds within the cavity 48, the agricultural product 14 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 24) and rollers 42 coupled to the tension arm 50, which is pivotable relative to the fixed rollers 42 (e.g., relative to the housing/frame of the baler 24). Accordingly, as the agricultural product 14 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more rollers and/or one or more belts of a bale wrap feeding assembly. The roller(s) and/or the belt(s) drive the bale wrap 58 toward a starter roller 60. The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 24, and the process of forming a subsequent bale may be initiated.

In certain embodiments, during the harvesting process, the conveying system 34 and the baler 24 may be periodically activated to transfer the agricultural product 14 from the accumulator 26 to the baler 24 and to form the bale 46. For example, as the agricultural harvester 10 traverses a field, the agricultural product 14 may accumulate within the accumulator 26. After a selected duration, the conveying system 34 may be activated to transfer the agricultural product 14 from the accumulator 26 to the baler 24. For example, the conveying system 34 may move the agricultural product 14 toward the baler 24 at a significantly faster rate than the air-assisted conveying system 22 moves the agricultural product 14 into the accumulator 26. Concurrently with activation of the conveying system 34, the baler 24 may be activated to initiate the bale forming process, as described above. After another selected duration, the conveying system 34 and the baler 24 may be deactivated to enable the accumulator 26 to collect additional agricultural product 14. In certain embodiments, the conveying system 34 and the baler 24 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 24 are periodically activated, the agricultural harvester 10 may utilize less energy during the harvesting process (e.g., as compared to continuously operating the conveying system and the baler).

In the illustrated embodiment, the agricultural harvester 10 includes a bale wrap assembly storage compartment 62 configured to store multiple bale wrap assemblies 64. In certain embodiments, each bale wrap assembly 64 includes a shaft and a bale wrap disposed about the shaft to form a roll of the bale wrap. However, in other embodiments, the shaft may be omitted, and the bale wrap may be arranged in a roll (e.g., with a hollow region at the center).

Furthermore, the agricultural harvester 10 (e.g., the bale wrapping system 56 of the agricultural harvester 10) includes a bale wrap feeding assembly configured to receive an active bale wrap assembly 66 from the bale wrap assembly storage compartment 62 and to feed the bale wrap 58 of the active bale wrap assembly 66 toward the bale 46 (e.g., toward the starter roller 60). The bale wrap feeding assembly includes one or more rollers and/or one or more belts driven by hydraulic motor(s). The roller(s) and/or the belt(s) are configured to engage the bale wrap and to drive the bale wrap toward the bale as the roller(s) and/or the belt(s) are driven by the hydraulic motor(s).

As discussed in detail below, in certain embodiments, each row unit includes a system to level the drum of the row unit 18 relative to adjacent drums. In certain embodiments, the system includes a hanger assembly configured to couple to a drum that is configured to pick an agricultural product. The hanger assembly includes a first vertical arm bracket and a second vertical arm bracket configured to couple to opposite sides of a housing of the drum. The first vertical arm bracket includes a first end and a second end opposite the first end, wherein the first end is configured to couple to the housing and the second end is coupled to a first hub coupled to a first roller. The second vertical arm bracket includes a third end and a fourth end opposite the third end, wherein the third end is configured to couple to the housing and the fourth end is coupled to a second hub coupled to a second roller. The hanger assembly is configured to hang on a toolbar of a header of the agricultural harvester via the first roller and the second roller. The first roller is coupled to a cam system configured to adjust (e.g., mechanically adjust) a position of the first roller relative to the toolbar to adjust a levelness of the drum relative to an adjacent drum hanging on the toolbar.

In certain embodiments, the system includes a carriage assembly configured to couple to a drum that is configured to pick an agricultural product. The carriage assembly includes a first pair of rollers configured to interface with a top of a toolbar of a header of the agricultural harvester with a first roller and a second roller of the first pair of rollers disposed adjacent opposite longitudinal ends of the carriage assembly. The carriage assembly also includes a second pair of rollers configured to interface with a side of the toolbar with a third roller and a fourth roller of the second pair of rollers disposed adjacent the opposite longitudinal ends of the carriage assembly. The system also includes a first adjustment mechanism having a first end coupled to a first longitudinal end of the carriage assembly and a second end configured to couple to a first side of a housing of the drum. The system further includes a second adjustment mechanism having a third end coupled to a second longitudinal end of the carriage assembly opposite the first longitudinal end and a fourth end configured to couple to a second side of the housing of the drum opposite the first side. The first adjustment mechanism and the second adjustment mechanism are configured adjust a levelness of the drum relative to an adjacent drum hanging on the toolbar.

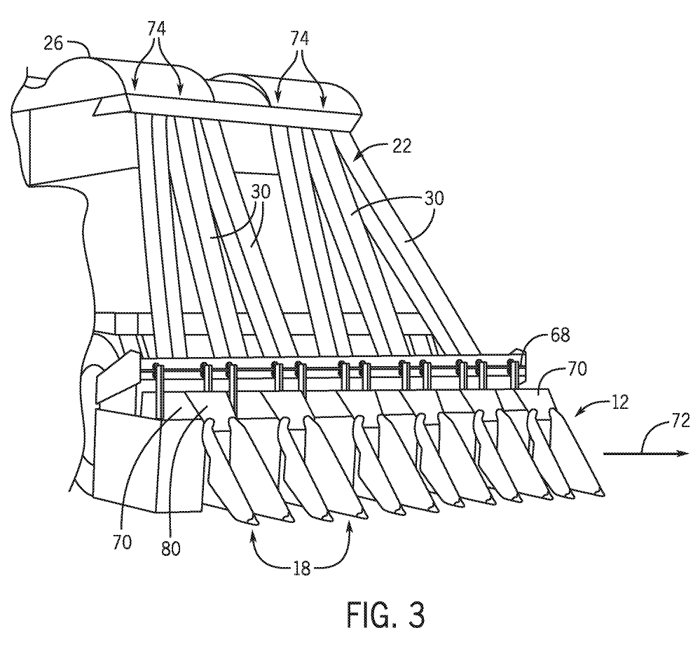

FIG. 3 is a perspective view of an embodiment of a header 12 that may be employed within the agricultural harvester of FIG. 1 and an embodiment of an air-assisted conveying system 22 that may be employed within the agricultural product transport assembly of FIG. 2. In the illustrated embodiment, the header 12 includes a chassis 68 configured to support multiple row units 18. In the illustrated embodiment, the header 12 includes six row units 18 (each having a drum 80). However, in other embodiments, the header may include more or fewer row units (e.g., 1, 2, 3, 4, 5, 7, 8, 9, 10, or more). Each row unit 18 includes a frame 70 (e.g., chassis, housing, etc.) of the drum 80 configured to support certain components of the row unit 18 (e.g., rotors, doffers, moistener columns, etc.). In addition, the frame 70 (and, thus, drum 80) of each row unit 18 is movably coupled to the chassis 68 (e.g., toolbar) of the header 12 to enable lateral movement of the row unit 18 along the chassis 68 (e.g., movement of the row unit with respect to a lateral axis 72 of the header 12. Each frame 70 may be movably coupled to the chassis 68 via any suitable type(s) of coupling assembly/assemblies, such as roller/track assembly/assemblies, protrusion/groove assembly/assemblies, etc. The row units 18 may be moved with respect to the lateral axis 72 to position the row units 18 for a desired row spacing. For example, the row units 18 may be laterally moved along the chassis 68 to align the row units 18 with rows of crops having a 30-inch row spacing, with rows of crops having a 40-inch row spacing, etc. Once each row unit 18 is moved to a desired lateral position along the chassis 68, a locking mechanism may be engaged to block movement of the row unit 18.

In certain embodiments, each row unit 18 includes two rotors (e.g., within the drum 80) positioned on opposite sides of a central path through the row unit 18 or on the same side of the central path. Each rotor includes multiple spindles (e.g., barbed spindles) extending into the central path, and the spindles are configured to engage a crop (e.g., cotton plant) along a substantial portion of the height of the crop. During operation of the agricultural harvester, the central path of the row unit 18 is aligned with a row of crops. Accordingly, as the agricultural harvester traverses the field, the row unit 18 receives each crop of the row, and the spindles of the rotors engage the crop. The rotors are driven to rotate, such that engagement of the spindles with the crop separates the agricultural product (e.g., seed cotton) from the plant stalk (e.g., the crop after the agricultural product is removed). The agricultural product removed from the crop collects on the spindles, and the agricultural product is removed from the spindles by doffers. Each doffer directs the agricultural product to a respective conveying chamber, and airflow generated by the air-assisted conveying system 22 moves the agricultural product from the conveying chambers to the accumulator 26 via a duct 30 of the air-assisted conveying system 22. After the agricultural product is removed from the spindles of each rotor, the spindles pass through a moistener column assembly to remove buildup of crop liquids (e.g., sap, etc.) from the spindles. As the rotors continue to rotate, the spindles engage a subsequent crop at the central path, while the plant stalk remains attached to the ground.

In the illustrated embodiment, the air-assisted conveying system 22 includes six ducts 30, and each duct 30 extends from a respective row unit 18 to the accumulator 26. While the air-assisted conveying system 22 includes six ducts 30 in the illustrated embodiment, in other embodiments, the air-assisted conveying system may include more or fewer ducts (e.g., one duct for each row unit). Each duct 30 may be formed from any suitable material(s) (e.g., metal, plastic, composite, etc.). In the illustrated embodiment, each duct 30 has a first end pivotally coupled to the accumulator 26 via a respective pivotal connection 74. In addition, each duct 30 has a second end coupled to the respective row unit 18. The pivotal connection 74 between the first end of each duct 30 and the accumulator 26 enables the second end of the duct 30 to move with respect to the lateral axis 72. Each pivot connection 74 may include any suitable structure(s) to facilitate rotation of the respective duct 30 with respect to the accumulator 26, such as a flexible hose, a pivot joint, etc. Furthermore, in the illustrated embodiment, each duct 30 is configured to telescope to adjust a length of the duct 30 (e.g., the distance between the first end and the second end of the duct). For example, in certain embodiments, each duct includes two portions slidably engaged with one another to enable the duct to telescope.

As discussed in detail below, in certain embodiments, each row unit 18 includes a system to level the drum 80 of the row unit 18 relative to adjacent drums 80. In certain embodiments, the system includes a hanger assembly configured to couple to a drum that is configured to pick an agricultural product. The hanger assembly includes a first vertical arm bracket and a second vertical arm bracket configured to couple to opposite sides of a housing 70 of the drum 80. The first vertical arm bracket includes a first end and a second end opposite the first end, wherein the first end is configured to couple to the housing 70 and the second end is coupled to a first hub coupled to a first roller. The second vertical arm bracket includes a third end and a fourth end opposite the third end, wherein the third end is configured to couple to the housing 70 and the fourth end is coupled to a second hub coupled to a second roller. The hanger assembly is configured to hang on the toolbar 68 of the header 12 of the agricultural harvester via the first roller and the second roller. The first roller is coupled to a cam system configured to adjust a position of the first roller relative to the toolbar to adjust a levelness of the drum 80 relative to an adjacent drum 80 hanging on the toolbar 68.

In certain embodiments, the system includes a carriage assembly configured to couple to the drum 80 that is configured to pick an agricultural product. The carriage assembly includes a first pair of rollers configured to interface with a top of the toolbar 68 of the header 12 of the agricultural harvester with a first roller and a second roller of the first pair of rollers disposed adjacent opposite longitudinal ends of the carriage assembly. The carriage assembly also includes a second pair of rollers configured to interface with a side of the toolbar 68 with a third roller and a fourth roller of the second pair of rollers disposed adjacent the opposite longitudinal ends of the carriage assembly. The system also includes a first adjustment mechanism having a first end coupled to a first longitudinal end of the carriage assembly and a second end configured to couple to a first side of the housing 70 of the drum 80. The system further includes a second adjustment mechanism having a third end coupled to a second longitudinal end of the carriage assembly opposite the first longitudinal end and a fourth end configured to couple to a second side of the housing of the drum opposite the first side. The first adjustment mechanism and the second adjustment mechanism are configured adjust a levelness of the drum 80 relative to an adjacent drum 80 hanging on the toolbar 68.

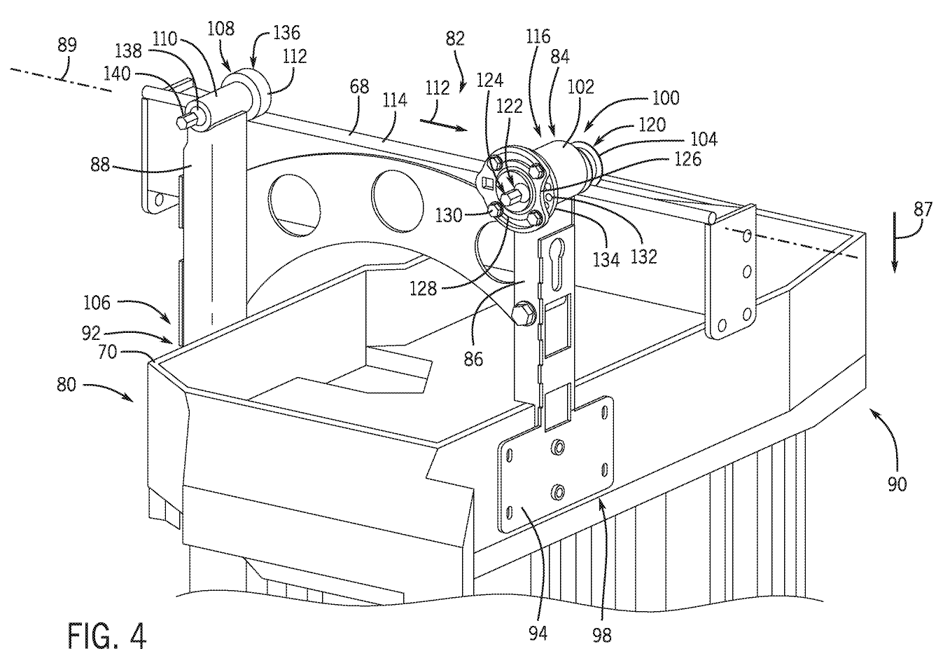

FIG. 4 is a perspective view of an embodiment of a system 82 for adjusting a leveling of the drum 80 of a row unit that may be employed on the header in FIG. 3. The system 82 includes a hanger assembly 84 configured to enable the drum 80 to hang on the toolbar 68 and the drum 80 to be moved along the toolbar 68 in the lateral direction 72 to ensure a desired spacing between the drums 80. The hanger assembly 84 is coupled to the housing 70 of the drum 80. The internal components of the drum 80 are not shown in FIG. 4.

The hangar assembly 84 includes a first vertical arm bracket 86 and a second vertical arm bracket 88 configured to couple to opposite sides 90, 92 of the housing 70 of the drum 80 via plates 94 and fasteners. A bracket 96 extends between (in the lateral direction 72) and is coupled to the first vertical arm bracket 86 and the second vertical arm bracket 88. Thus, the first vertical arm bracket 86 and the second vertical arm bracket 88 flanks the bracket 96. The first vertical arm bracket 86 and the second vertical arm bracket 88 extend in a direction 87 that is transverse to the lateral direction 72 (and a longitudinal axis 89 of the tool bar 68) toward the housing 70. The first vertical arm bracket 86 includes a first end 98 and a second end 100 opposite the first end 98. The first end 98 is coupled to the housing 70 and the second end 100 is coupled to a first hub 102 coupled to a first roller 104. The second vertical arm bracket 88 includes a third end 106 and a fourth end 108 opposite the third end 106, wherein the third end 106 is configured to couple to the housing 70 and the fourth end 108 is coupled to a second hub 110 coupled to a second roller 112. The hanger assembly 84 is configured to hang on the toolbar 68 of a header of an agricultural harvester via the first roller 104 and the second roller 112. As depicted, the first roller 104 and the second roller 104 are interfacing with a top surface 114 of the tool bar 68.

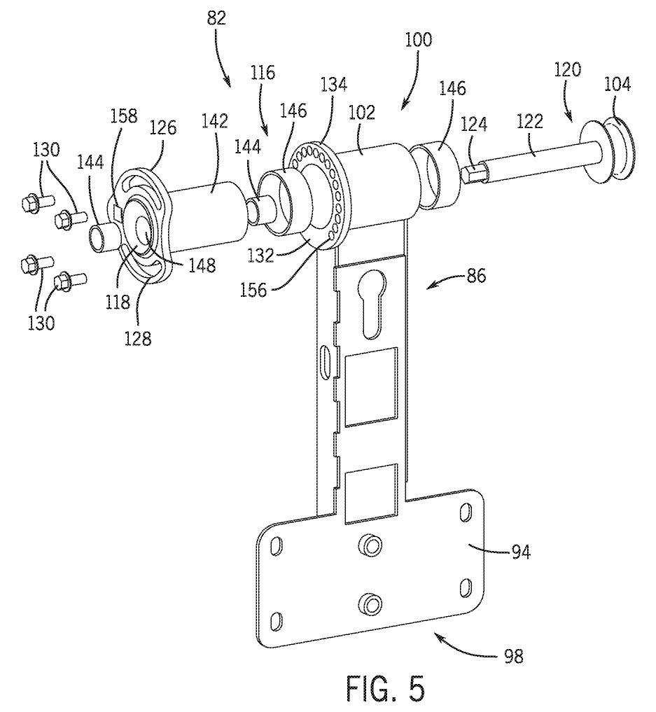

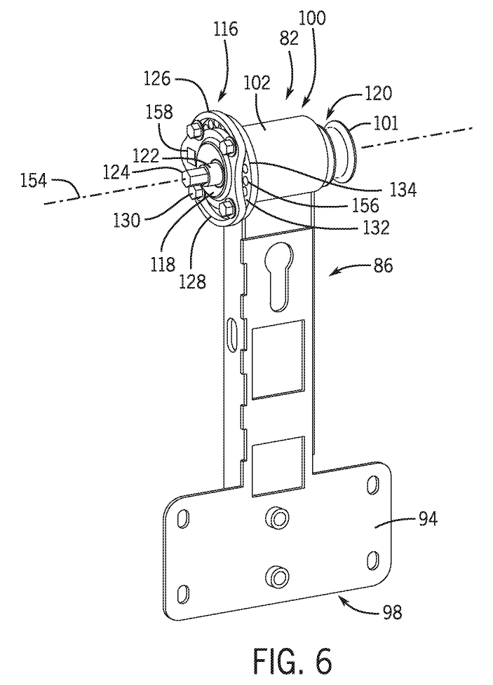

The first roller 104 is coupled to a cam system 116 configured to adjust a position of the first roller 104 relative to the toolbar 68 to adjust a levelness of the drum 80 relative to an adjacent drum hanging on the toolbar 68. The cam system 116 includes a cam (see FIGS. 5 and 6) coupled to an offset holed bushing 118, wherein the cam is disposed within the first hub 102. The first roller 104 is coupled to an end 120 of a shaft 122 and the shaft 122 includes a hex-shaped end 124 opposite the end 120. The shaft 122 is disposed within and extends through both the first hub 102 and the cam so that first roller 104 and the hex-shaped end 124 are respectively disposed on opposite sides of the first hub 102. The hex-shaped end 124 of the shaft 122 is configured to be utilized to turn the offset holed bushing 118 to change the position of the first roller 104 relative to the toolbar 68. The larger the offset (i.e., between the center of the bushing 118 and the hole in the bushing 118), the greater the level of adjustment. The cam system 116 includes a hold collar 126 disposed on an end of the cam adjacent where the hex-shaped end 124 of the shaft 122 extends out of the offset holed bushing 118, and wherein the hold collar 126 is configured to maintain the position of the first roller 104 relative to the toolbar 68. The hold collar 126 includes one or more slots 128 that extend in a circumferential direction relative to a rotational axis of the offset holed bushing 118. The hold collar 126 is configured to be secured, via one or more fasteners 130 (e.g., bolts), to an end face 132 of a collar 134 disposed on the hub that interfaces with the hold collar 126. In certain embodiments, one fastener is 130 is utilized to hold the position and other fasteners 130 apply additional load on the hold collar 126.

The cam system 116 is configured to adjust the first roller 104 between a high position relative to the toolbar 68, a low position relative to the toolbar 68, and a neutral (or default) position located between the high position and the low position. As depicted, the first roller 104 (and the offset-holed bushing 118) are in the neutral position. When the first roller 104 is in the high position, the first vertical arm bracket 86 is lowered away from the toolbar 68. When the first roller 104 is in the low position, the first vertical arm bracket 86 is raised toward the toolbar 68.

With respect to the other side of the hanger assembly 84, the second roller 112 is coupled to an end 136 of a shaft 138. The shaft 138 is disposed within and extends through second hub 110. An opposite end 140 of the shaft 138 and the second roller 112 are disposed on opposite sides of the second hub 110.

FIGS. 5-7 are different views of a portion of an embodiment of the system 82 in FIG. 4 for adjusting the leveling of the drum of the row unit. The first vertical arm bracket 86 is depicted in FIGS. 5-7. The first vertical arm bracket 86 includes a first end 98 and a second end 100 opposite the first end 98. The first end 98 is configured to couple to the housing of the drum and the second end 100 is coupled to the first hub 102 (e.g., annular hub) coupled to the first roller 104.

The first roller 104 is coupled to the cam system 116 configured to adjust a position of the first roller 104 relative to the toolbar to adjust a levelness of the drum relative to an adjacent drum hanging on the toolbar. The cam system 116 includes a cam 142 coupled to the offset holed bushing 118, wherein the cam 116 is disposed within the first hub 102. As depicted in FIG. 5, the outer surface of the cam 142 and the inner surface of the first hub 102 are smooth. In certain embodiments, the outer surface of the cam 142 and the inner surface of the first hub 102 may include a spline or a series of keyway that are clocked that would allow for the adjustment to different positions. A pair of needle bearings 144 are disposed in opposite ends of the offset holed bushing 118. Also, a pair of bushings 146 are disposed in opposite ends of the first hub 102.

The first roller 104 is coupled to the end 120 of the shaft 122 and the shaft 122 includes the hex-shaped end 124 opposite the end 120. The shaft 122 is disposed within and extends through both the first hub 102 and the cam 142 (as well the needle bearings 144 and the bushings 146) so that first roller 104 and the hex-shaped end 124 are respectively disposed on opposite sides of the first hub 102. The hex-shaped end 124 of the shaft 122 is configured to be utilized to turn the offset holed bushing 118 to change the position of the first roller 104 relative to the toolbar. The larger the offset (i.e., between the center of the bushing 118 and a hole 148 in the bushing 118), the greater the level of adjustment.

The cam system 116 includes the hold collar 126 disposed on an end 150 of the cam 142 adjacent where the hex-shaped end 124 of the shaft 122 extends out of the offset holed bushing 118. The hold collar 126 is configured to maintain the position of the first roller 104 relative to the toolbar 68. The hold collar 126 includes one or more slots 128 that extend in a circumferential direction 152 relative to a rotational axis 154 of the offset holed bushing 118. The hold collar 126 is configured to be secured, via one or more fasteners 130 (e.g., bolts), to an end face 132 of a collar 134 disposed on the hub that interfaces with the hold collar 126. In certain embodiments, one fastener is 130 is utilized to hold the position and other fasteners 130 apply additional load on the hold collar 126. The fasteners 130 are inserted into the slots 128 and screwed within threaded holes 156 located on the end face 132 of the collar 134. The threaded holes 156 circumferentially spaced apart along the end face 132 of the collar 134. The hold collar 126 includes a square-shaped opening or hole 158. The square-shaped opening 158 is configured to enable a breaker bar to be utilized to raise or lower the drum.

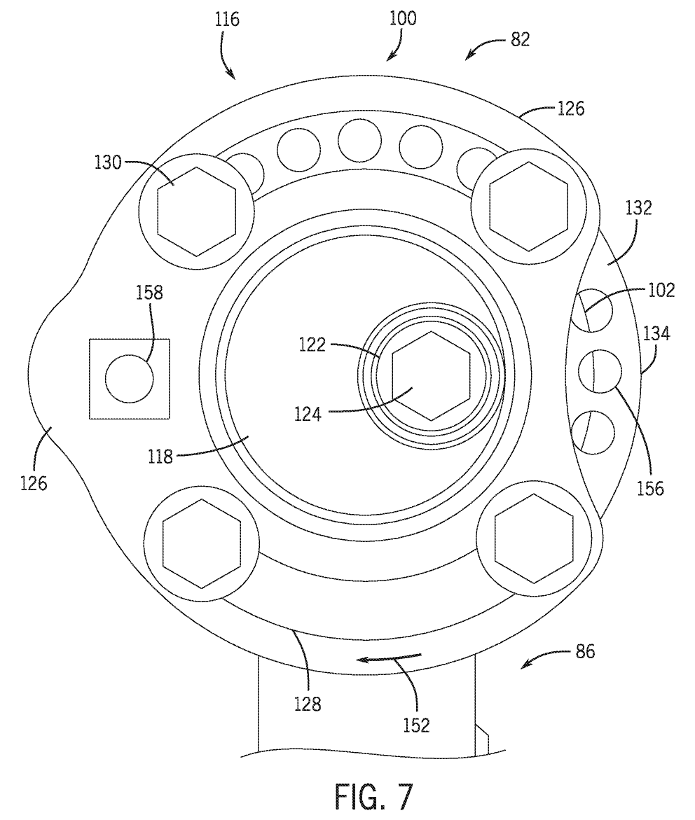

The cam system 116 is configured to adjust the first roller 104 between a high position relative to the toolbar, a low position relative to the toolbar, and a neutral position located between the high position and the low position. As depicted, the first roller 104 (and the offset-holed bushing 118) are in the neutral position. When the first roller 104 is in the high position, the first vertical arm bracket 86 is lowered away from the toolbar. When the first roller 104 is in the low position, the first vertical arm bracket 86 is raised toward the toolbar. As depicted in FIG. 7, the offset-holed bushing 118 (and, thus, the first roller) is in a neutral position.

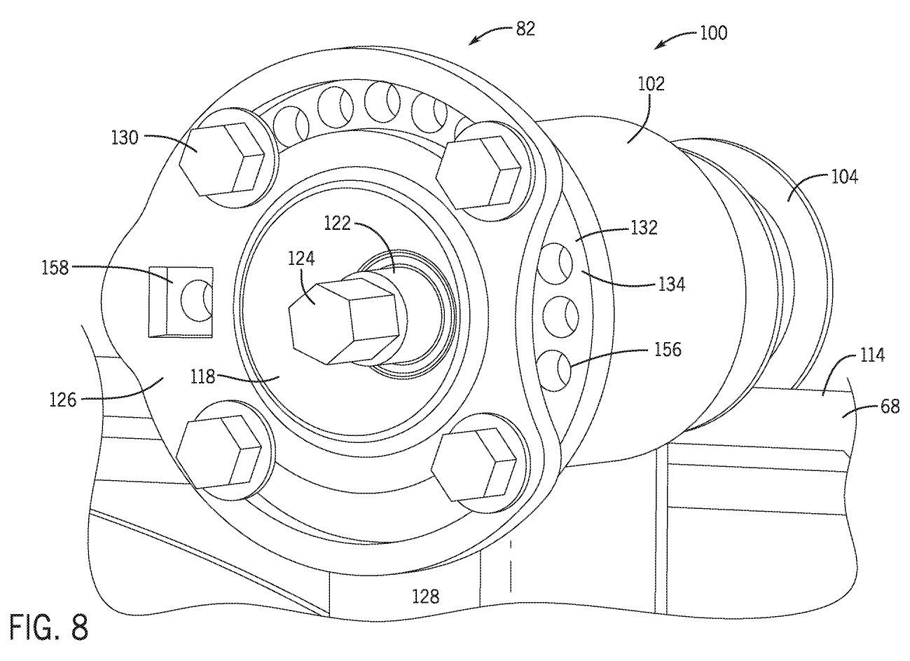

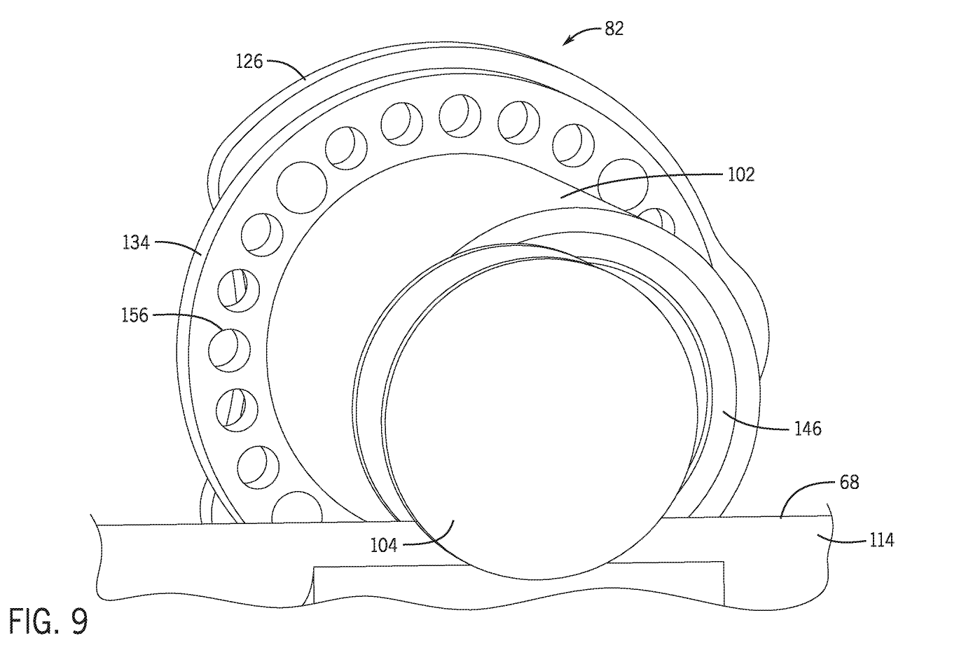

FIGS. 8 and 9 are front and rear perspective views, respectively, of a portion of the system 82 in FIG. 4 with the first roller 104 and the offset-holed bushing 118 in a neutral position. As depicted in FIGS. 8 and 9, the first roller 104 is offset from a center of the first hub 102. In addition, the first roller 104 is engaged with top surface 114 of the tool bar 68.

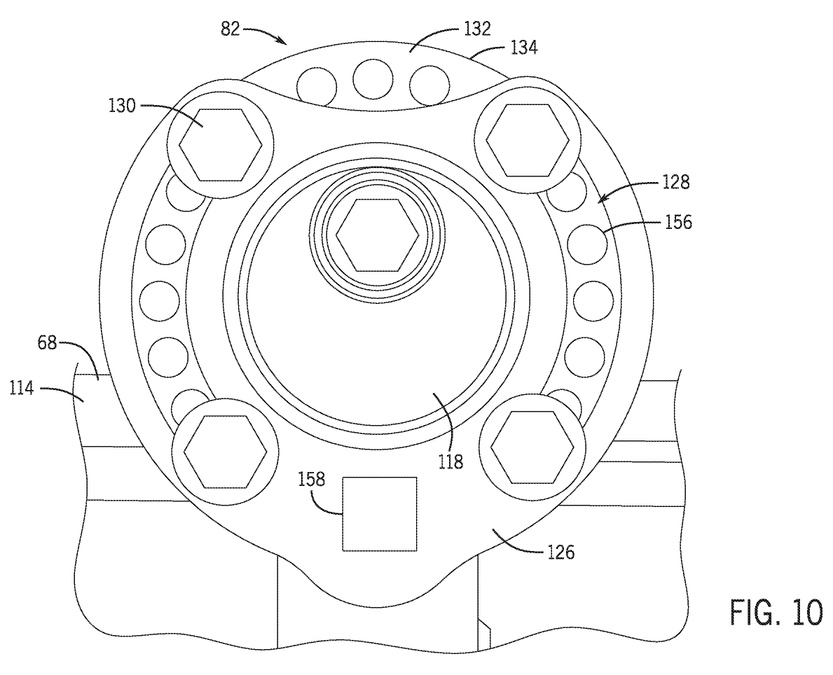

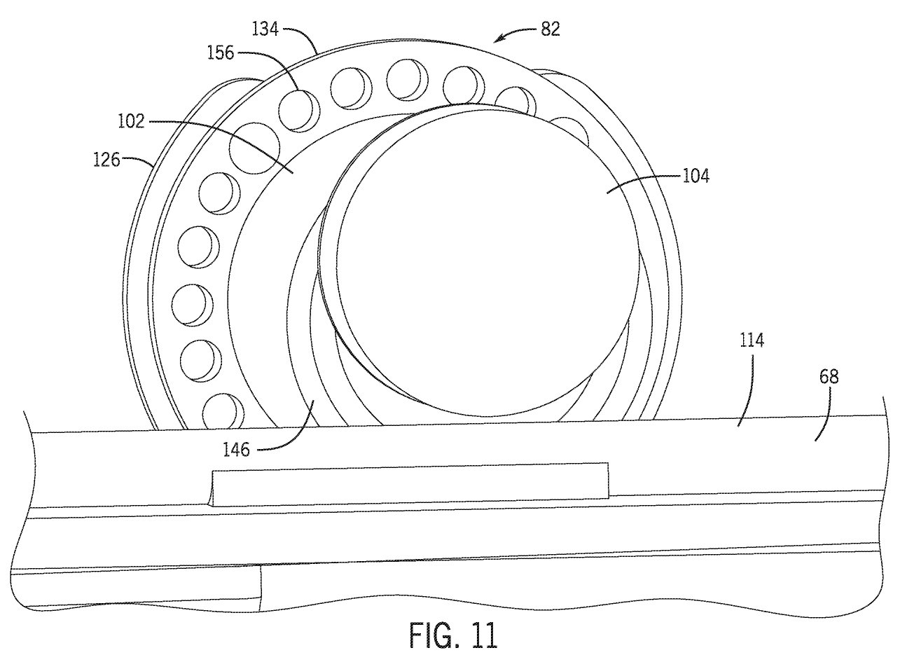

FIGS. 10 and 11 are an end view and a rear perspective view, respectively, of a portion of the system 82 in FIG. 4 with the first roller 104 and the offset-holed bushing 118 in a high position. As depicted in FIGS. 10 and 11, the first roller 104 is offset from a center of the first hub 102. In addition, the first roller 104 is located above and not engaged with top surface 114 of the tool bar 68.

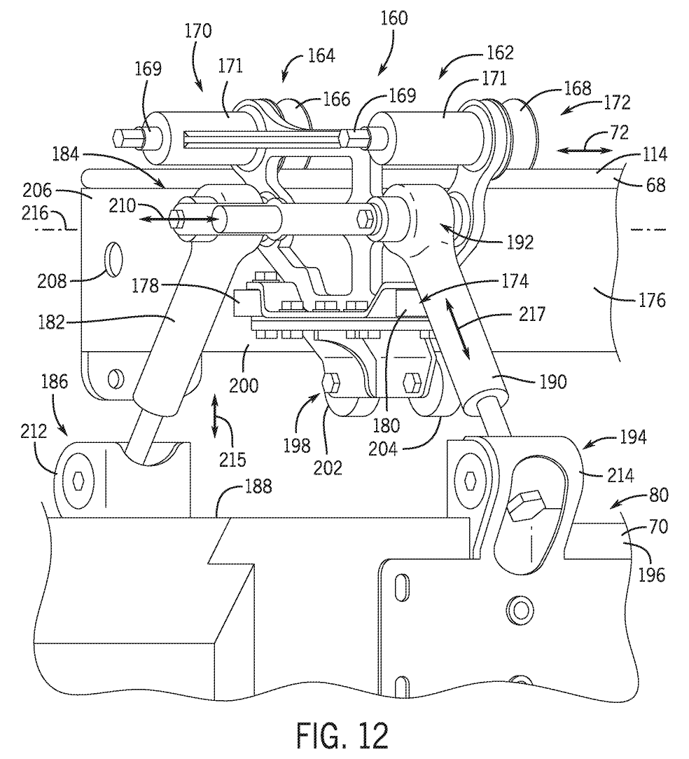

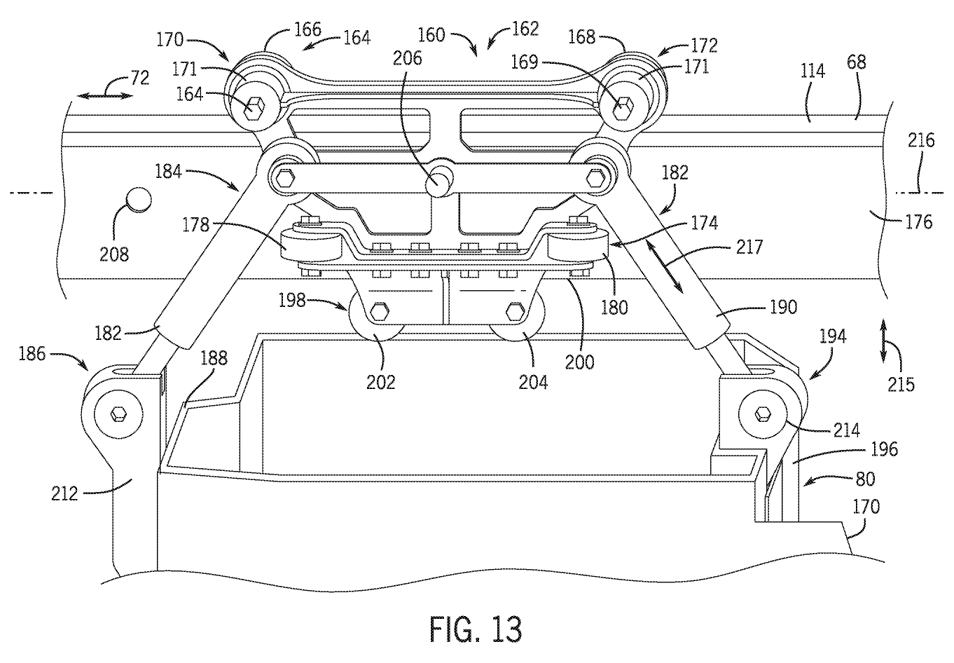

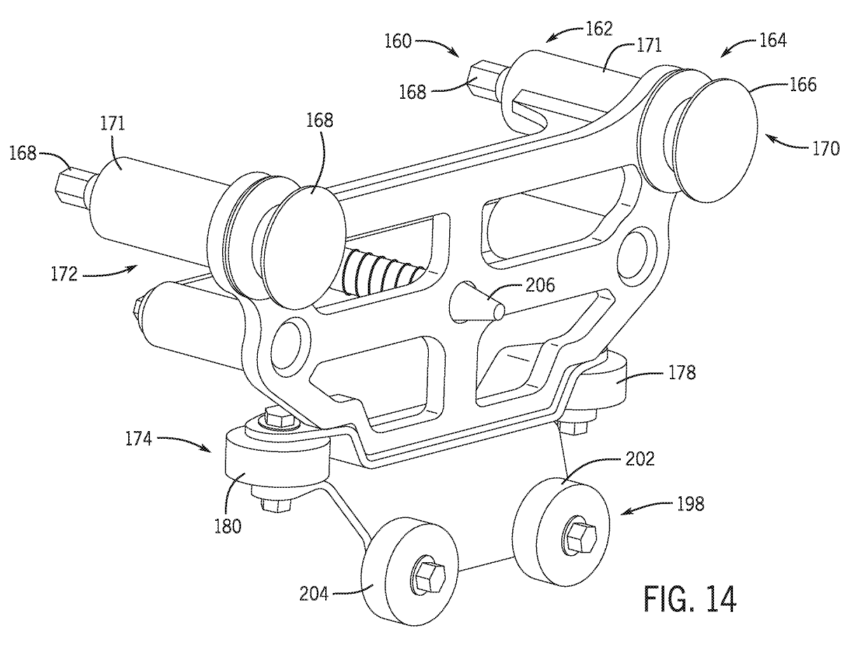

FIGS. 12 and 13 are different views of another embodiment of a system 160 for adjusting a leveling of a drum 80 of a row unit that may be employed on the header in FIG. 3. FIG. 14 is rear perspective view of a portion of the system 160 (i.e., the carriage assembly 162). The system 160 includes a carriage assembly 162 configured to enable the drum 80 to hang on the toolbar 68 and the drum 80 to be moved along the toolbar 68 in the lateral direction 72 in FIG. 3 to ensure a desired spacing between the drums 80. The carriage assembly 162 is coupled to the housing 70 of the drum 80. The internal components of the drum 80 are not shown in FIGS. 12 and 13.

The carriage assembly 162 includes a first pair 164 of rollers configured to interface with a top surface 114 of the toolbar 68 with a roller 166 and a roller 168 of the first pair 164 of rollers disposed adjacent opposite longitudinal ends 170, 172 of the carriage assembly 162. The rollers 166, 168 are coupled to respective 169 shafts that are disposed within and extend through respective hubs 171. The carriage assembly 162 also includes a second pair 174 of rollers configured to interface with a side 176 of the toolbar 68 with a roller 178 and a roller 180 of the second pair 174 of rollers disposed adjacent the opposite longitudinal ends 170, 172 of the carriage assembly 162. The system 160 also includes a first adjustment mechanism 182 having a first end 184 coupled to a first longitudinal end 170 of the carriage assembly 162 and a second end 186 configured to couple to a first side 188 of the housing 70 of the drum 80. The system 160 further includes a second adjustment mechanism 190 having a third end 192 coupled to a second longitudinal end 172 of the carriage assembly 162 opposite the first longitudinal end 170 and a fourth end 194 configured to couple to a second side 196 of the housing 70 of the drum 80 opposite the first side 188. The first adjustment mechanism 182 and the second adjustment mechanism 190 are configured adjust a levelness of the drum 80 relative to an adjacent drum hanging on the toolbar 68. The first adjustment mechanism 182 and the second adjustment mechanism 190 are configured to enable constant pressure on the first pair 164 of rollers and the second pair 174 of rollers at all times.

The carriage assembly 162 further includes a third pair 198 of rollers configured to interface with a bottom 200 of the toolbar 68. The third pair 198 of rollers includes a roller 202 and a roller 204 that interfaces with the bottom 200 of the toolbar 68. The carriage assembly 162 further includes a pin 206 configured to be inserted into a hole 208 of the tool bar 68 to set a lateral position of the drum 80 along the toolbar 68. The pin 206 is centrally located on the carriage assembly 162 and may be moved in and out in along direction 210.

The system 160 includes a first bracket 212 coupled to the second end 186 of the first adjustment mechanism 182 and configured to couple to the first side 188 of the housing 70 of the drum 80. The system 160 also includes a second bracket 214 coupled to the fourth end 194 of the second adjustment mechanism 190 and configured to couple to the second side 196 of the housing 70 of the drum 80. As depicted, the first adjustment mechanism 182 and the second adjustment mechanism 190 extend at respective oblique angles (in opposite directions) relative to a longitudinal axis 216 of the toolbar 86, and the first adjustment mechanism 182 and the second adjustment mechanism 190 are configured to adjust the levelness of the drum 80 in both a vertical direction 215 and an angular direction 217.

As depicted, the first adjustment mechanism 182 and the second adjustment mechanism 190 are a first tie bolt (or first bolted turnbuckle) and a second tie bolt (or second turnbuckle), respectively. In certain embodiments, the first adjustment mechanism 182 and the second adjustment mechanism 190 are a first hydraulic cylinder and a second hydraulic cylinder, respectively.

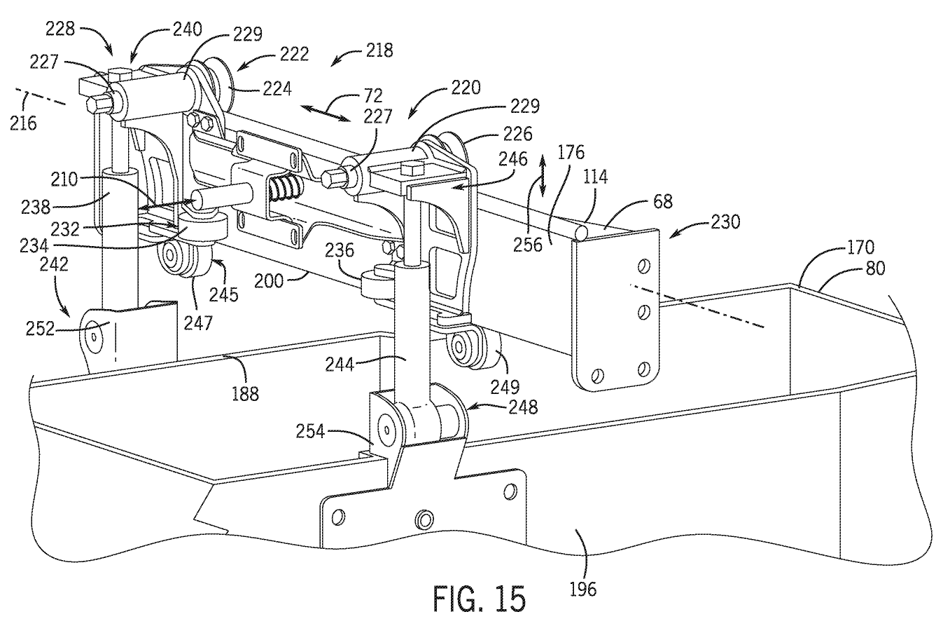

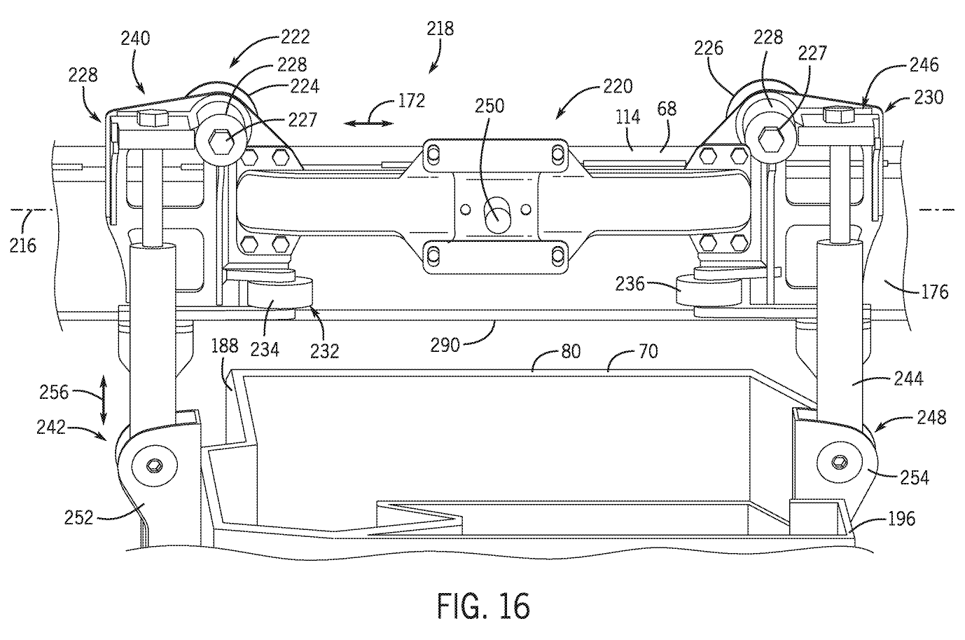

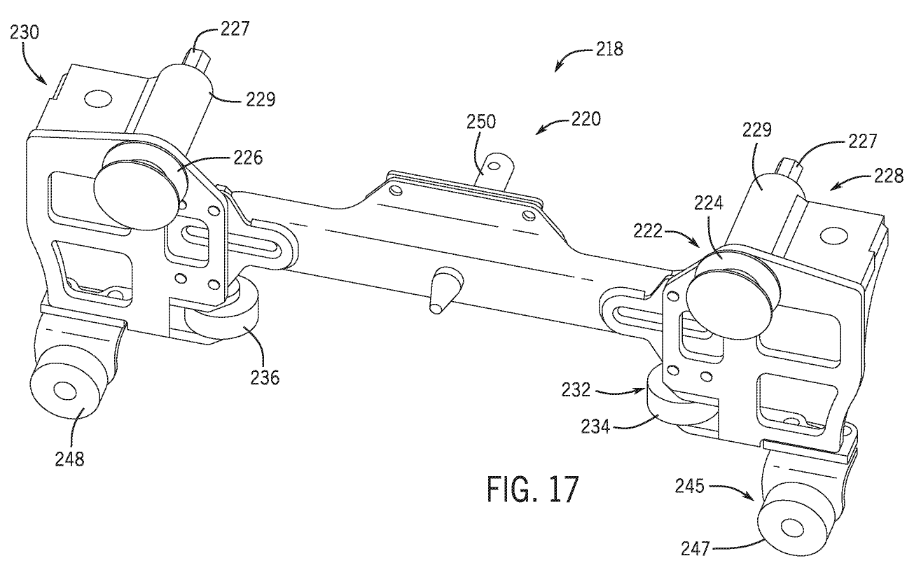

FIGS. 15 and 16 are different views of a further embodiment of a system 218 for adjusting a leveling of a drum 80 of a row unit that may be employed on the header in FIG. 3. FIG. 17 is rear perspective view of a portion of the system 218 (i.e., the carriage assembly 220). The system 218 includes a carriage assembly 220 configured to enable the drum 80 to hang on the toolbar 68 and the drum 80 to be moved along the toolbar 68 in the lateral direction 72 in FIG. 3 to ensure a desired spacing between the drums 80. The carriage assembly 220 is coupled to the housing 70 of the drum 80. The internal components of the drum 80 are not shown in FIGS. 15 and 16.

The carriage assembly 218 includes a first pair 222 of rollers configured to interface with a top surface 114 of the toolbar 68 with a roller 224 and a roller 226 of the first pair 222 of rollers disposed adjacent opposite longitudinal ends 228, 230 of the carriage assembly 218. The rollers 224, 226 are coupled to respective 227 shafts that are disposed within and extend through respective hubs 229. The carriage assembly 218 also includes a second pair 232 of rollers configured to interface with a side 176 of the toolbar 68 with a roller 234 and a roller 236 of the second pair 232 of rollers disposed adjacent the opposite longitudinal ends 228, 230 of the carriage assembly 218. The system 218 also includes a first adjustment mechanism 238 having a first end 240 coupled to a first longitudinal end 228 of the carriage assembly 218 and a second end 242 configured to couple to a first side 188 of the housing 70 of the drum 80. The system 218 further includes a second adjustment mechanism 244 having a third end 246 coupled to a second longitudinal end 230 of the carriage assembly 218 opposite the first longitudinal end 228 and a fourth end 248 configured to couple to a second side 196 of the housing 70 of the drum 80 opposite the first side 188. The first adjustment mechanism 238 and the second adjustment mechanism 244 are configured adjust a levelness of the drum 80 relative to an adjacent drum hanging on the toolbar 68. The first adjustment mechanism 238 and the second adjustment mechanism 244 are configured to enable constant pressure on the first pair 222 of rollers and the second pair 232 of rollers at all times.

The carriage assembly 218 further includes a third pair 245 of rollers configured to interface with a bottom 200 of the toolbar 68. The third pair 245 of rollers includes a roller 247 and a roller 249 that interfaces with the bottom 200 of the toolbar 68. The carriage assembly 218 further includes a pin 250 configured to be inserted into a hole of the tool bar 68 to set a lateral position of the drum 80 along the toolbar 68. The pin 250 is centrally located on the carriage assembly 218 and may be moved in and out in along direction 210.

The system 218 includes a first bracket 252 coupled to the second end 242 of the first adjustment mechanism 238 and configured to couple to the first side 188 of the housing 70 of the drum 80. The system 218 also includes a second bracket 254 coupled to the fourth end 248 of the second adjustment mechanism 244 and configured to couple to the second side 196 of the housing 70 of the drum 80. As depicted, the first adjustment mechanism 238 and the second adjustment mechanism 244 extend in a vertical direction 256 relative to a longitudinal axis 216 of the toolbar 86, and the first adjustment mechanism 238 and the second adjustment mechanism 244 are configured to adjust the levelness of the drum 80 in the vertical direction 256.

As depicted, the first adjustment mechanism 238 and the second adjustment mechanism 244 are a first tie bolt (or first bolted turnbuckle) and a second tie bolt (or second turnbuckle), respectively. In certain embodiments, the first adjustment mechanism 238 and the second adjustment mechanism 244 are a first hydraulic cylinder and a second hydraulic cylinder, respectively.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A system for adjusting a leveling of a drum of a row unit of an agricultural harvester, comprising:
a hanger assembly configured to couple to a drum that is configured to pick an agricultural product, wherein the hanger assembly comprises:
a first vertical arm bracket and a second vertical arm bracket configured to couple to opposite sides of a housing of the drum; and
wherein the first vertical arm bracket comprises a first end and a second end opposite the first end, wherein the first end is configured to couple to the housing and the second end is coupled to a first hub coupled to a first roller;
wherein the second vertical arm bracket comprises a third end and a fourth end opposite the third end, wherein the third end is configured to couple to the housing and the fourth end is coupled to a second hub coupled to a second roller, wherein the hanger assembly is configured to hang on a toolbar of a header of the agricultural harvester via the first roller and the second roller; and
wherein the first roller is coupled to a cam system configured to adjust a position of the first roller relative to the toolbar to adjust a levelness of the drum relative to an adjacent drum hanging on the toolbar.

2. The system of claim 1, wherein the cam system further comprises a cam coupled to an offset holed bushing, wherein the cam is disposed within the first hub.

3. The system of claim 2, wherein the first roller is coupled to an end of a shaft and the shaft comprises a hex-shaped end opposite the end.

4. The system of claim 3, wherein the shaft is disposed within and extends through both the first hub and the cam so that first roller and the hex-shaped end are respectively disposed on opposite sides of the first hub.

5. The system of claim 4, wherein the hex-shaped end of the shaft is configured to be utilized to turn the offset holed bushing to change the position of the first roller relative to the toolbar.

6. The system of claim 5, wherein the cam system comprises a hold collar disposed on an end of the cam adjacent where the hex-shaped end of the shaft extends out of the offset holed bushing, and wherein the hold collar is configured to maintain the position of the first roller relative to the toolbar.

7. The system of claim 6, wherein the hold collar comprises one or more slots that extend in a circumferential direction relative to a rotational axis of the offset holed bushing, and the hold collar is configured to be secured, via one or more fasteners, to an end face of a collar disposed on the hub that interfaces with the hold collar.

8. The system of claim 1, wherein the cam system is configured to adjust the first roller between a high position relative to the toolbar, a low position relative to the toolbar, and a neutral position located between the high position and the low position.

9. The system of claim 8, wherein, when the first roller is in the high position, the first vertical arm bracket is lowered away from the toolbar, and, when the first roller is in the low position, the first vertical arm bracket is raised toward the toolbar.

10. A system for adjusting a leveling of a drum of a row unit of an agricultural harvester, comprising:
a carriage assembly configured to couple to a drum that is configured to pick an agricultural product, wherein the carriage assembly comprises:
a first pair of rollers configured to interface with a top of a toolbar of a header of the agricultural harvester with a first roller and a second roller of the first pair of rollers disposed adjacent opposite longitudinal ends of the carriage assembly; and
a second pair of rollers configured to interface with a side of the toolbar with a third roller and a fourth roller of the second pair of rollers disposed adjacent the opposite longitudinal ends of the carriage assembly;
a first adjustment mechanism having a first end coupled to a first longitudinal end of the carriage assembly and a second end configured to couple to a first side of a housing of the drum; and
a second adjustment mechanism having a third end coupled to a second longitudinal end of the carriage assembly opposite the first longitudinal end and a fourth end configured to couple to a second side of the housing of the drum opposite the first side; and
wherein the first adjustment mechanism and the second adjustment mechanism are configured adjust a levelness of the drum relative to an adjacent drum hanging on the toolbar.

11. The system of claim 10, wherein the first adjustment mechanism and the second adjustment mechanism are configured to enable constant pressure on the first pair of rollers and the second pair of rollers at all times.

12. The system of claim 10, wherein the first adjustment mechanism and the second adjustment mechanism comprise a first tie bolt and a second tie bolt, respectively.

13. The system of claim 10, wherein the first adjustment mechanism and the second adjustment mechanism comprise a first hydraulic cylinder and a second hydraulic cylinder, respectively.

14. The system of claim 10, wherein the first adjustment mechanism and the second adjustment mechanism extend in a vertical direction relative to a longitudinal axis of the toolbar, and the first adjustment mechanism and the second adjustment mechanism are configured to adjust the levelness of the drum in the vertical direction.

15. The system of claim 10, wherein the first adjustment mechanism and the second adjustment mechanism extend at respective oblique angles relative to a longitudinal axis of the toolbar, and the first adjustment mechanism and the second adjustment mechanism are configured to adjust the levelness of the drum in a vertical direction and an angular direction.

16. The system of claim 15, wherein the carriage assembly further comprises a third pair of rollers configured to interface with a bottom of the toolbar.

17. The system of claim 10, wherein the carriage assembly further comprises a pin configured to be inserted into a hole of the toolbar to set a lateral position of the drum along the toolbar.

18. A row unit for an agricultural harvester, comprising:
a drum configured to pick an agricultural product and comprising a housing; and
a hanger assembly coupled to the housing of the drum, wherein the hanger assembly comprises:
a first vertical arm bracket and a second vertical arm bracket coupled to opposite sides of the housing of the drum; and
a bracket extending between and coupled to the first vertical arm bracket and the second vertical arm bracket;
wherein the first vertical arm bracket comprises a first end and a second end opposite the first end, wherein the first end is coupled to the housing and the second end is coupled to a first hub coupled to a first roller;
wherein the second vertical arm bracket comprises a third end and a fourth end opposite the third end, wherein the third end is coupled to the housing and the fourth end is coupled to a second hub coupled to a second roller, wherein the hanger assembly is configured to hang on a toolbar of a header of the agricultural harvester via the first roller and the second roller; and
wherein the first roller is coupled to a cam system configured to adjust a position of the first roller relative to the toolbar to adjust a levelness of the drum relative to an adjacent drum hanging on the toolbar.

19. The row unit of claim 18, wherein the cam system further comprises a cam coupled to an offset holed bushing, the cam is disposed within the first hub, the first roller is coupled to an end of a shaft and the shaft comprises a hex-shaped end opposite the end, and the shaft is disposed within and extends through both the first hub and the cam so that first roller and the hex-shaped end are respectively disposed on opposite sides of the first hub.

20. The row unit of claim 19, wherein the hex-shaped end of the shaft is configured to be utilized to turn the offset holed bushing to change the position of the first roller relative to the toolbar, the cam system comprises a hold collar disposed on an end of the cam adjacent where the hex-shaped end of the shaft extends out of the offset holed bushing, and wherein the hold collar is configured to maintain the position of the first roller relative to the toolbar.
